(19) United States
(12) Patent Application Publication
(10) Pub. No.: US 2018/0254004 A1
(43) Pub. Date: Sep. 6, 2018

(54) INTEGRATED CIRCUIT FOR DRIVING DISPLAY PANEL AND FAN-OUT COMPENSATION METHOD THEREOF

(71) Applicant: Novatek Microelectronics Corp., Hsinchu (TW)

(72) Inventor: Chao-Chih Hsiao, Taipei City (TW)

(73) Assignee: Novatek Microelectronics Corp., Hsinchu (TW)

(21) Appl. No.: 15/450,038

(22) Filed: Mar. 6, 2017

(51) Int. Cl. G09G 3/20

(52) U.S. Cl. CPC G09G 3/2092; G09G 2310/0297; G09G 2310/0291; G09G 2310/061; G09G 2310/08; G09G 2330/021; G09G 2300/043; G09G 2310/0289

(57) ABSTRACT

A driving integrated circuit (IC) configured to drive a display panel and a fan-out compensation method thereof are provided. The driving IC includes a driving channel circuit and a compensation control circuit. The driving channel circuit outputs a pixel voltage in a normal operation period to drive a data line of the display panel. The driving channel circuit includes a compensation element configured to adjust an output resistance value, an output slew rate or an output timing of the output terminal of the driving channel circuit according to a setting value. The compensation control circuit is coupled to the data line of the display panel and the compensation element of the driving channel circuit, detects resistance information with respect to the data line in an initialization period, correspondingly adjusts the setting value according to the resistance information and outputs the setting value to the compensation element.

### BACKGROUND

### Field of the Invention

The invention related to a display circuit and more particularly, to a driving integrated circuit (IC) of a display panel and a fan-out compensation method thereof.

### Description of Related Art

FIG. 1 is a schematic diagram of a layout of a display panel 120. The display panel 120 illustrated in FIG. 1 includes a display region 121 and other regions (e.g., a frame region). A plurality of data lines (or referred to as source lines) are disposed in the display panel 120, which are data lines Ch[1], Ch[n−1], Ch[n], Ch[n+1], . . . and Ch[1026] illustrated in FIG. 1, for example. A plurality of driving channel circuits of a driving integrated circuit (IC) 110 are respectively coupled to the data lines Ch[1] to Ch[1026] of the display panel 120 in a one-to-one manner. The driving IC 110 may transmit a plurality of pixel voltages to pixel unit circuits (not shown) in the display region 121 through the data lines Ch[1] to Ch[1026].

Different data lines Ch[1] to Ch[1026] usually vary in lengths due to positions. Along with the increase in the size of the display panel 120, length variance among different data lines is also increased. The length variance among the data lines results in resistance difference. The resistance difference among the data lines influences delay of each pixel voltage transmitted to the pixel unit circuits. When the resistance difference among different data lines is overly large, it would result in poor display quality of a screen.

### SUMMARY

The invention provides a driving integrated circuit (IC) and a fan-out compensation method thereof for compensating delay difference caused by resistance difference among data lines.

According to an embodiment of the invention, a driving IC configured to drive a display panel is provided. The driving IC includes a driving channel circuit and a compensation control circuit. An output terminal of the driving channel circuit is configured to couple to a data line of the display panel. The driving channel circuit is configured to output a pixel voltage to drive the data line in a normal operation period. The driving channel circuit includes a compensation element. The compensation element is configured to adjust an output resistance value, an output slew rate or an output timing of the output terminal of the driving channel circuit according to a setting value. The compensation control circuit is coupled to the data line of the display panel and the compensation element of the driving channel circuit. The compensation control circuit is configured to detect resistance information with respect to the data line in an initialization period. The compensation control circuit is configured to correspondingly adjust the setting value according to the resistance information and output the setting value to the compensation element.

According to an embodiment of the invention, a fan-out compensation method of a driving IC is provided. The driving IC is configured to drive the display panel. The fan-out compensation method includes: outputting a pixel voltage to drive a data line of the display panel in a normal operation period by an output terminal of an driving channel circuit; detecting resistance information with respect to the data line in an initialization period by a compensation control circuit; correspondingly adjusting a setting value according to the resistance information by the compensation control circuit; and outputting the setting value to the driving channel circuit to adjust an output resistance value, an output slew rate or an output timing of the output terminal of the driving channel circuit by the compensation control circuit.

To sum up, in the driving IC and the fan-out compensation method thereof provided by the embodiments of the invention, the compensation control circuit is used. The compensation control circuit can detect resistance information with respect to the data line of the panel. The compensation control circuit can correspondingly adjust the output resistance value, the output slew rate or the output timing of the output terminal of the driving channel circuit of the driving IC according to the resistance information, so as to compensate the delay difference caused by the resistance difference among the data lines.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a layout of a display panel.

FIG. 2 is a schematic circuit block diagram of a driving integrated circuit (IC) according to an embodiment of the invention.

FIG. 3 is a schematic circuit block diagram of a driving IC according to another embodiment of the invention.

FIG. 4 is a schematic flowchart of a fan-out compensation method of the driving IC according to an embodiment of the invention.

FIG. 5 is a schematic circuit block diagram of the compensation control circuit depicted in FIG. 2 or FIG. 3 according to an embodiment of the invention.

FIG. 6 is a schematic signal timing diagram of the circuits depicted in FIG. 5 according to an embodiment of the invention.

FIG. 7 is a schematic signal waveform diagram of the voltage depicted in FIG. 5 in the charging time according to an embodiment of the invention.

FIG. 8 is a schematic signal waveform diagram of the voltage depicted in FIG. 5 in the charging time according to another embodiment of the invention.

FIG. 9 is a schematic circuit block diagram of the variable resistor and the controller depicted in FIG. 5 according to an embodiment of the invention.

FIG. 10 is a schematic circuit block diagram of the variable resistor and the controller depicted in FIG. 5 according to another embodiment of the invention.

FIG. 11 is a schematic circuit block diagram of the compensation control circuit depicted in FIG. 2 or FIG. 3 according to another embodiment of the invention.

FIG. 12 is a schematic circuit block diagram of the compensation control circuit depicted in FIG. 2 or FIG. 3 according to yet another embodiment of the invention.

FIG. 13 is a schematic signal timing diagram of the circuits depicted in FIG. 12 according to an embodiment of the invention.

FIG. 14 is a schematic circuit block diagram of the compensation control circuit depicted in FIG. 2 or FIG. 3 according to still another embodiment of the invention.

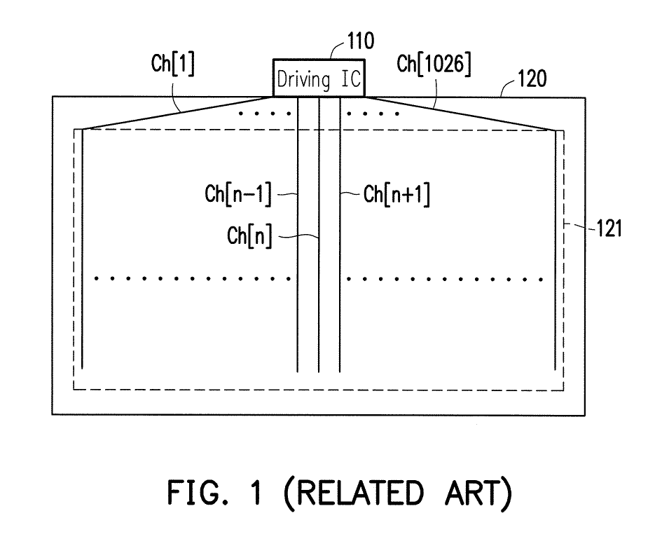

### DESCRIPTION OF EMBODIMENTS

A term “couple” used in the full text of the disclosure (including the claims) refers to any direct and indirect connections. For instance, if a first device is described to be coupled to a second device, it is interpreted as that the first device is directly coupled to the second device, or the first device is indirectly coupled to the second device through other devices or connection means. Moreover, wherever possible, components/members/steps using the same referential numbers in the drawings and description refer to the same or like parts. Components/members/steps using the same referential numbers or using the same terms in different embodiments may cross-refer related descriptions.

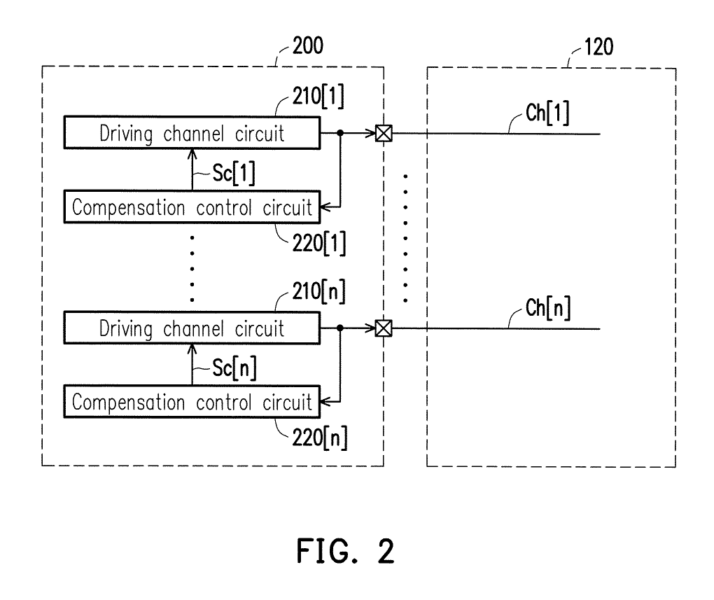

FIG. 2 is a schematic circuit block diagram of a driving integrated circuit (IC) 200 according to an embodiment of the invention. The driving IC 200 is configured to drive a plurality of data lines of a drive the display panel 120, which are data lines Ch[1] to Ch[n] illustrated in FIG. 2, for example. The driving IC 200 includes a plurality of driving channel circuits and a plurality of compensation control circuits. For example, the driving IC 200 includes n driving channel circuits 210[1] to 210[n] and n compensation control circuits 220[1] to 220[n], where n is an integer and may be determined based on design requirement. Output terminals of the driving channel circuits 210[1] to 210[n] may be coupled to the data lines Ch[1] to Ch[n] of the display panel 120 through pads. In a normal operation period, the driving channel circuits 210[1] to 210[n] may output corresponding pixel voltages to drive the data lines Ch[1] to Ch[n] and pixel unit circuits (not shown). Each of the driving channel circuits 210[1] to 210[n] includes a compensation element (which will be described below) and other elements, such as a conventional latch, a conventional digital-to-analog converter (DAC) and so on.

The compensation control circuits 220[1] to 220[n] are respectively coupled to the data lines Ch[1] to Ch[n] of the display panel 120 through the pads. The compensation control circuits 220[1] to 220[n] may detect impedances of the data lines Ch[1] to Ch[n] in an initialization period to obtain resistance information. The compensation control circuits 220[1] to 220[n] may correspondingly adjust setting values Sc[1] to Sc[n] according to the resistance information with respect to the data lines Ch[n] to Ch[n]. The compensation control circuits 220[1] to 220[n] are further respectively coupled to the compensation elements of the driving channel circuits 210[1] to 210[n] to output the setting values to the compensation elements (which will be described below). The compensation elements may adjust output resistance values, output slew rates or output timings of the output terminals of the driving channel circuits 210[1] to 210[n] according to the setting values Sc[1] to Sc[n].

For example (but not limited to), the compensation control circuits 220[1] to 220[n] may reset voltages of the data lines Ch[1] to Ch[n] to a specific predetermined reset voltage (e.g., a ground voltage or any other fixed voltage, which is determined based on design requirement) in a reset time of the initialization period. After the reset time ends, the compensation control circuits 220[1] to 220[n] may charge the data lines Ch[1] to Ch[n] in a charging time of the initialization period, such that the voltages of the data lines Ch[1] to Ch[n] may be pulled up. Based on impedances difference among the data lines Ch[1] to Ch[n], rising speeds of the voltages of the data lines Ch[1] to Ch[n] may vary. After the charging time ends, different rising speeds result in different voltage levels of the data lines Ch[1] to Ch[n]. Thus, the compensation control circuits 220[1] to 220[n] may detect levels of the voltages of the data lines Ch[1] to Ch[n] in the detection time of the initialization period to serve the voltage levels as the resistance information. The compensation control circuits 220[1] to 220[n] may correspondingly adjust the setting values Sc[1] to Sc[n] according to the levels (i.e., the resistance information) of the voltages of the data lines Ch[1] to Ch[n].

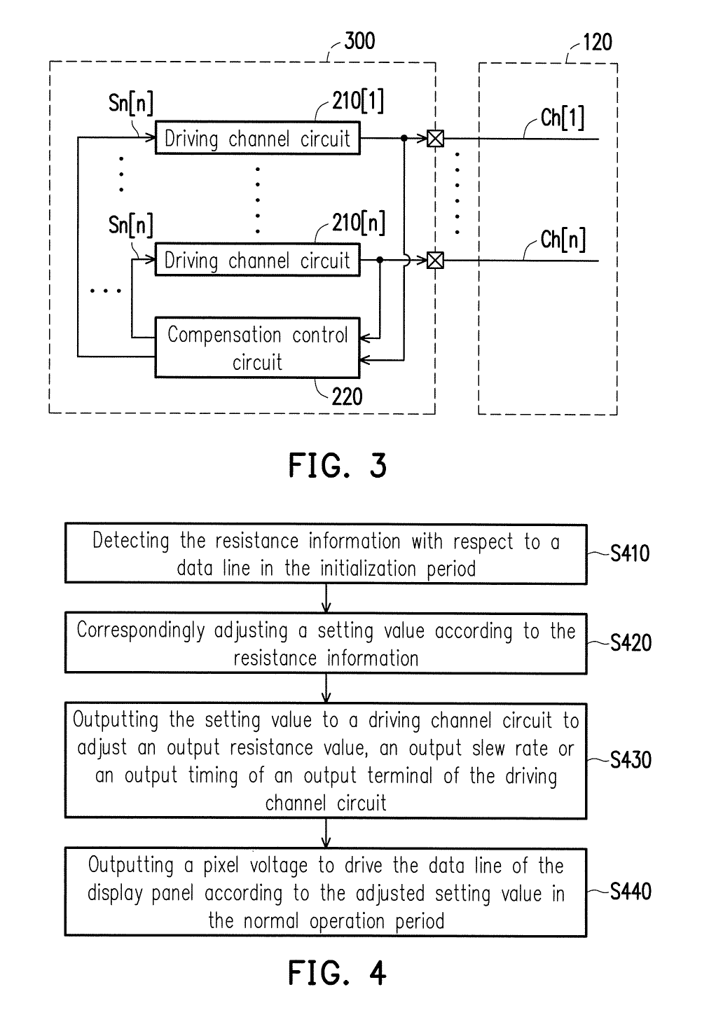

FIG. 3 is a schematic circuit block diagram of a driving IC 300 according to another embodiment of the invention. The driving IC 300 is configured to drive a plurality of data line of the display panel 120, which are data lines Ch[1] to Ch[n] illustrated in FIG. 3, for example. The driving IC 300 includes a plurality of driving channel circuits and a plurality of compensation control circuits. For example, the driving IC 300 includes a driving channel circuit group and a compensation control circuit 220. The driving channel circuit group includes n driving channel circuits 210[1] to 210[n], where n is an integer and may be determined based on design requirement. Output terminals of the driving channel circuits 210[1] to 210[n] may be coupled to the data lines Ch[1] to Ch[n] of the display panel 120 through pads. In a normal operation period, the driving channel circuits 210[1] to 210[n] may output corresponding pixel voltages to drive the data lines Ch[1] to Ch[n] and pixel unit circuits (not shown).

The compensation control circuit 220 illustrated in FIG. 3 may inferred with reference to the description related to the compensation control circuits 220[1] to 220[n] illustrated in FIG. 2. The driving channel circuits 210[1] to 210[n] may share the compensation control circuit 220 in time-division. The compensation control circuit 220 are coupled to the data lines Ch[1] to Ch[n] of the display panel 120 through the pads. The compensation control circuit 220 may detect impedances of the data lines Ch[1] to Ch[n] in an initialization period to obtain resistance information. The compensation control circuit 220 may correspondingly adjust setting values Sc[1] to Sc[n] according to the resistance information with respect to the data lines Ch[1] to Ch[n]. The compensation control circuit 220 is further respectively coupled to the compensation elements of the driving channel circuits 210[1] to 210[n] to output the setting values to the compensation elements (which will be described below).

FIG. 4 is a schematic flowchart of a fan-out compensation method of the driving IC 200 or 300 according to an embodiment of the invention. In step S410, the compensation control circuit detects resistance information with respect to a data line in the initialization period. For example, the compensation control circuit 220[1] illustrated in FIG. 2 may detect the impedance of the data line Ch[1] in the initialization period to obtain the resistance information. Or alternatively, the compensation control circuit 220 illustrated in FIG. 3 may detect the impedance of the data line Ch[1] in the initialization period to obtain the resistance information.

In step S420, the compensation control circuit correspondingly adjusts a setting value according to the resistance information. For example, the compensation control circuit 220[1] illustrated in FIG. 2 may correspondingly adjust the setting value Sc[1] according to the resistance information with respect to the data line Ch[1]. Or alternatively, the compensation control circuit 220 illustrated in FIG. 3 may correspondingly adjust the setting value Sc[1] according to the resistance information with respect to the data line Ch[1].

In step S430, the compensation control circuit outputs the setting value to a driving channel circuit to adjust an output resistance value, an output slew rate or an output timing of an output terminal of the driving channel circuit. For example, the compensation control circuit 220[1] illustrated in FIG. 2 may output the setting value Sc[1] to the driving channel circuit 210[1] to adjust the output resistance value, the output slew rate or the output timing of the output terminal of the driving channel circuit 210[1]. Or alternatively, the compensation control circuit 220 illustrated in FIG. 3 may output the setting value Sc[1] to the driving channel circuit 210[1] to adjust the output resistance value, the output slew rate or the output timing of the output terminal of the driving channel circuit 210[1].

For example, if the impedance of the data line Ch[1] is large, the compensation control circuit 220[1] (or 220) may output the setting value Sc[1] to the driving channel circuit 210[1], so as to reduce the output resistance value of the output terminal of the driving channel circuit 210[1], reduce the output slew rate of the output terminal of the driving channel circuit 210[1] or speed up the output timing of the output terminal of the driving channel circuit 210[1] (i.e., reduce an output delay time). If the impedance of the data line Ch[1] is small, the compensation control circuit 220[1] (or 220) may output the setting value Sc[1] to the driving channel circuit 210[1], so as to increase the output resistance value of the output terminal of the driving channel circuit 210[1] increase the output slew rate of the output terminal of the driving channel circuit 210[1], or slow down the output timing of the output terminal of the driving channel circuit 210[1] (i.e., increase the output delay time).

After the initialization period ends, the driving IC 200 or 300 enters the normal operation period. In step S440, the output terminal of the driving channel circuit outputs a pixel voltage to drive the data line of the display panel according to the adjusted setting value in the normal operation period. For example, the output terminal of the driving channel circuit 210[1] illustrated in FIG. 2 or FIG. 3 may output the pixel voltage to drive the data line Ch[1] of the display panel 120 according to the adjusted setting value Sc[1] in the normal operation period.

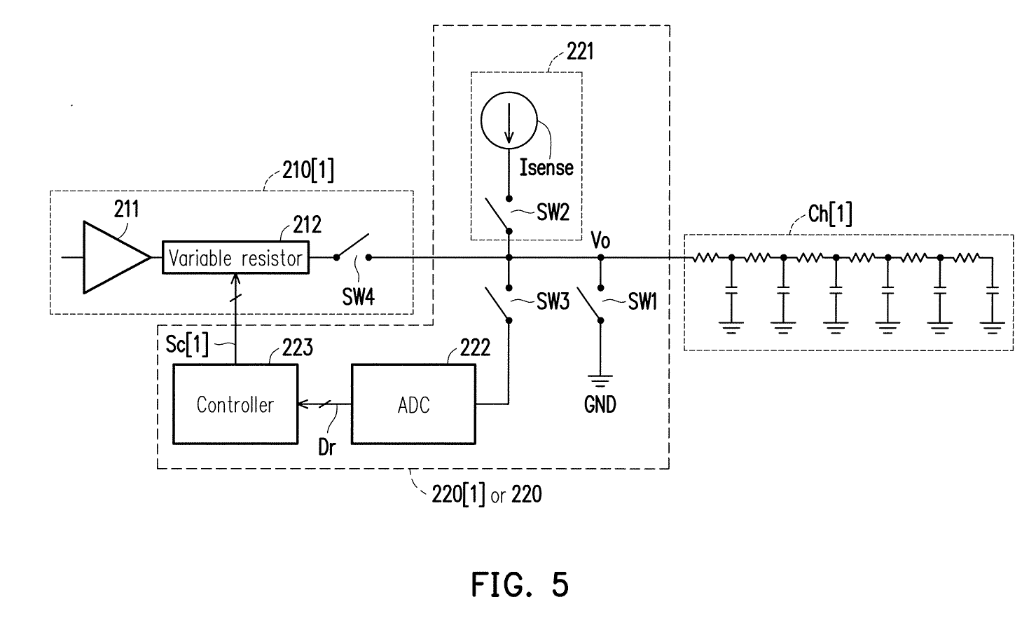

FIG. 5 is a schematic circuit block diagram of the compensation control circuit 220[1] depicted in FIG. 2 (or the compensation control circuit 220 illustrated in FIG. 3) according to an embodiment of the invention. The other compensation control circuits illustrated in FIG. 2 may be inferred with reference to the description related to embodiment illustrated in FIG. 5. FIG. 5 further illustrates the driving channel circuit 210[1] and the data line Ch[1]. The data line Ch[1] illustrated in FIG. 5 includes a plurality of parasitic resistors and a plurality of parasitic capacitors. The other driving channel circuits and the other data lines illustrated in FIG. 2 may be inferred with reference to the description related to embodiment illustrated in FIG. 5. The other driving channel circuits and the other data lines illustrated in FIG. 3 may also be inferred with reference to the description related to embodiment illustrated in FIG. 5.

The driving channel circuit 210[1] illustrated in FIG. 5 includes an output buffer 211, a variable resistor 212 and a switch SW4. Based on design requirement, the driving channel circuit 210[1] may further include other elements, such as a conventional latch, a conventional DAC and so on. The aforementioned other elements (not shown) may be coupled to an input terminal of the output buffer 211. An output terminal of the output buffer 211 is configured to output a pixel voltage.

In the embodiment illustrated in FIG. 5, the variable resistor 212 may serve as the compensation element of the driving channel circuit 210[1]. A first terminal of the variable resistor 212 is coupled to the output terminal of the output buffer 211. The variable resistor 212 is controlled by the setting value Sc[1] of the compensation control circuit 220[1] (or 220) to adjust a resistance of the variable resistor 212, i.e., the compensation control circuit 220[1] (or 220) illustrated in FIG. 5 may adjust the output resistance value of the output terminal of the driving channel circuit 210[1] according to the setting value Sc[1]. A first terminal of the switch SW4 is coupled to a second terminal of the variable resistor 212. A second terminal of the switch SW4 is coupled to the data line Ch[1] of the display panel 120. In the initialization period, the switch SW4 is turned off. In the normal operation period, the switch SW4 is turned on.

In the embodiment illustrated in FIG. 5, the compensation control circuit 220[1] (or 220) includes a reset switch SW1, a charging source circuit 221, a detection switch SW3, an analog-to-digital converter (ADC) 222 and a controller 223. A first terminal of the reset switch SW1 is configured to couple to the data line Ch[1] of the display panel 120. A second terminal of the reset switch SW1 is coupled to a reset voltage (e.g., a ground voltage GND or any other fixed voltage). The charging source circuit 221 is configured to couple to the data line Ch[1] of the display panel 120. In the charging time of the initialization period, the charging source circuit 221 charges the data line Ch[1]. In the normal operation period, the charging source circuit 221 does not influence the data line Ch[1]. In the embodiment illustrated in FIG. 5, the charging source circuit 221 includes a current source Isense and a charging switch SW2. A first terminal of the charging switch SW2 is coupled to a current output terminal of the current source Isense. A second terminal of the charging switch SW2 is configured to couple to the data line Ch[1] of the display panel 120.

A first terminal of the detection switch SW3 is configured to couple to the data line Ch[1] of the display panel 120. An input terminal of the ADC 222 is coupled to a second terminal of the detection switch SW3. An input terminal of the controller 223 is coupled to an output terminal of the ADC 222 to receive a digital value Dr corresponding to the resistance information with respect to the data line Ch[1]. The controller 223 converts the digital value Dr into the setting value Sc[1] and outputs the setting value Sc[1] to the variable resistor 212 (i.e., the compensation element of the driving channel circuit 210[1]).

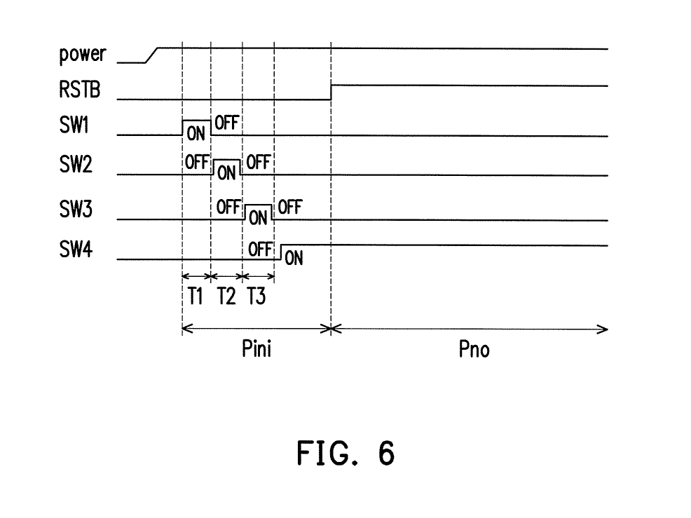

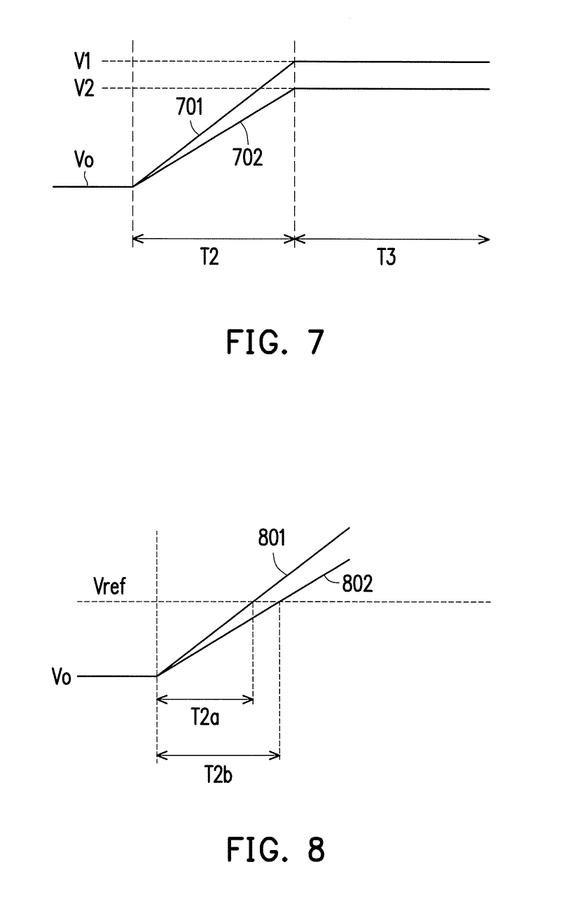

FIG. 6 is a schematic signal timing diagram of the circuits depicted in FIG. 5 according to an embodiment of the invention. In FIG. 6, the horizontal axis represents time, and the vertical axis represents voltage. After a system power supply (e.g., power illustrated in FIG. 6) is powered on, the driving IC 200 (or 300) enters an initialization period Pini. The initialization period Pini may be defined by a system reset signal RSTB. When the system reset signal RSTB is at a low potential, the driving IC 200 (or 300) enters the initialization period Pini. When the system reset signal RSTB is at a high potential, the driving IC 200 (or 300) ends the initialization period Pini and enters a normal operation period Pno.

The reset switch SW1, the charging switch SW2, the detection switch SW3 and the switch SW4 are controlled by the controller 223. In a reset time T1 of the initialization period Pini, the reset switch SW1 is turned on, and the charging switch SW2, the detection switch SW3 and the switch SW4 are turned off. A voltage of the data line Ch[1] is dropped down to a reset voltage (e.g., a ground voltage GND) in the reset time T1.

In a charging time T2 of the initialization period Pini, the charging switch SW2 is turned on, and the reset switch SW1, the detection switch SW3 and the switch SW4 are turned off. The output terminal of the driving channel circuit 210[1] is charged in the charging time T2, so as to pull up a voltage Vo of the output terminal of the driving channel circuit 210[1]. A rising speed of the voltage Vo is influenced by the impedance of the data line Ch[1]. The impedance of the data line Ch[1] is dependent on a length of the data line Ch[1]. In a detection time T3 of the initialization period Pini, the detection switch SW3 is turned on, and the reset switch SW1, the charging switch SW2 and the switch SW4 are turned off. Thus, the controller 223 may detect the impedance of the data line Ch[1] in the detection time T3.

FIG. 7 is a schematic signal waveform diagram of the voltage Vo depicted in FIG. 5 in the charging time T2 according to an embodiment of the invention. In FIG. 7, the horizontal axis represents time, and the vertical axis represents voltage. In the charging time T2 of the initialization period Pini, the charging source circuit 221 charges the output terminal of the driving channel circuit 210[1], and thus, the voltage Vo is pulled up. If the impedance of the data line Ch[1] is small, the rising speed of the voltage Vo is fast (as presented by a curve 701 in FIG. 7). If the impedance of the data line Ch[1] is large, the rising speed of the voltage Vo is slow (as presented by a curve 702 in FIG. 7). In a condition that the charging time T2 is fixed (the same), different rising speeds lead the voltage Vo to have difference levels when the charging time T2 ends. For example, in a condition that the charging time T2 is the same, referring to FIG. 7, a voltage level presented by the curve 701 is V1, and a voltage level presented by the curve 702 is V2 when the charging time T2 ends. The controller 223 may obtain the level of the voltage Vo in the detection time T3. Due to the rising speed of the voltage Vo being influenced by the impedance of the data line Ch[1], the impedance of the data line Ch[1] may be learned according to the level of the voltage Vo.

FIG. 8 is a schematic signal waveform diagram of the voltage Vo depicted in FIG. 5 in the charging time T2 according to another embodiment of the invention. In FIG. 8, the horizontal axis represents time, and the vertical axis represents voltage. In a condition that a reference voltage Vref is fixed (the same), different rising speeds leads to difference in the times spent on reaching a level of the reference voltage Vref from the level of the voltage Vo. If the impedance of the data line Ch[1] is small, the rising speed of the voltage Vo is fast (as presented by a curve 801 in FIG. 8). If the impedance of the data line Ch[1] is large, the rising speed of the voltage Vo is slow (as presented by a curve 802 in FIG. 8). The controller 223 may calculate the time for reaching the level of the reference voltage Vref from the level of voltage Vo. For example, the curve 801 illustrated in FIG. 8 shows that the time for reaching the level of the reference voltage Vref from the level of the voltage Vo is T2a. At the end of the time T2a (i.e., the charging time T2), the driving IC 200 (or 300) enters the detection time T3. In addition, the curve 802 illustrated in FIG. 8 shows that the time for reaching the level of the reference voltage Vref from the level of the voltage Vo is T2b. At the end of the time T2b (i.e., the charging time T2), the driving IC 200 (or 300) enters the detection time T3. Due to the rising speed of the voltage Vo being influenced by the impedance of the data line Ch[1], the impedance of the data line Ch[1] may be learned according to the time for reaching the level of the reference voltage Vref from the level of the voltage Vo.

Referring to FIG. 5 and the FIG. 6, in the detection time T3, the controller 223 may learn the resistance information with respect to the data line Ch[1] and convert the resistance information with respect to the data line Ch[1] into the setting value Sc[1]. After the detection time T3 ends, the reset switch SW1, the charging switch SW2 and the detection switch SW3 are turned off. Thus, the compensation control circuit 220[1] (or 220) does not influence operations of the driving channel circuit 210[1] and the data line Ch[1]. After the initialization period Pini ends, the driving IC 200 or 300 enters the normal operation period Pno. In the normal operation period Pno, the reset switch SW1, the charging switch SW2 and the detection switch SW3 are turned off, and the switch SW4 is turned on.

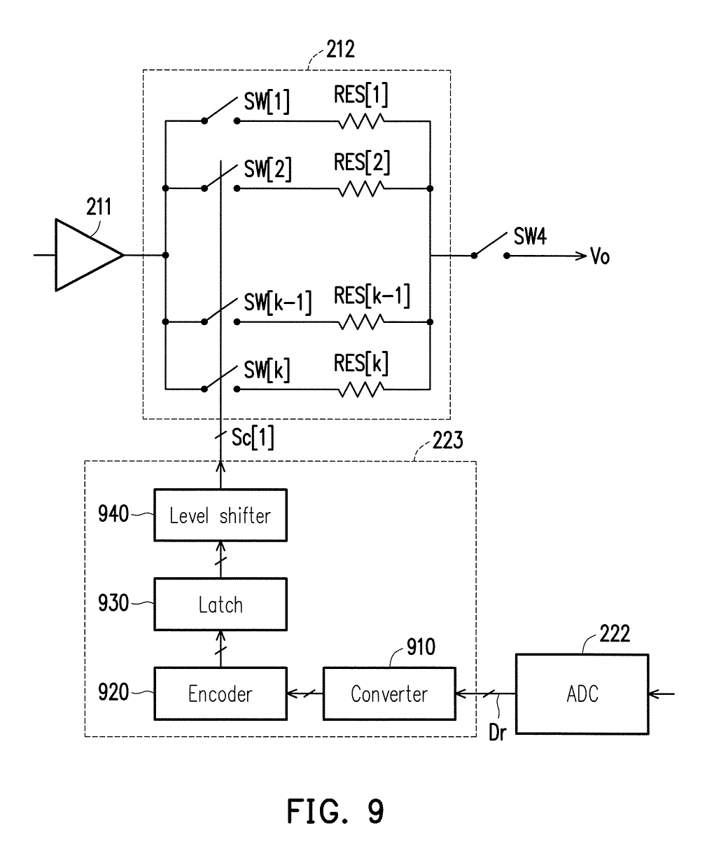

FIG. 9 is a schematic circuit block diagram of the variable resistor 212 and the controller 223 depicted in FIG. 5 according to an embodiment of the invention. The controller 223 illustrated in FIG. 9 includes a converter 910, an encoder 920, a latch 930 and a level shifter 940. An input terminal of the converter 910 is coupled to the output terminal of the ADC 222 to receive the digital value Dr. The converter 910 may convert the digital value Dr into a corresponding resistance. The corresponding resistance may represent the impedance of the data line Ch[1]. An input terminal of the encoder 920 is coupled to an output terminal of the converter 910 to receive the corresponding resistance. The encoder 920 may encode the corresponding resistance to obtain the setting value Sc[1]. An input terminal of the latch 930 is coupled to output terminal of the encoder 920 to receive and latch the setting value Sc[1]. An input terminal of the level shifter 940 is coupled to an output terminal of the latch 930 to receive the setting value Sc[1]. An output terminal of the level shifter 940 is coupled to the variable resistor 212 (i.e., the compensation element) to provide the setting value Sc[1].

The variable resistor 212 illustrated in FIG. 9 includes k switches (e.g., SW[1], SW[2], . . . , SW[k−1] and SW[k] illustrated in FIG. 9) and k resistors (e.g., RES[1], RES[2], RES[k−1] and RES[k] illustrated in FIG. 9). k is an integer and may be determined based on design requirement. Control terminals of the switches SW[1] to SW[k] are coupled to the output terminal of the level shifter 940 of the controller 223 to receive different bits of the setting value Sc[1]. First terminals of the switches SW[1] to SW[k] are jointly coupled to the output terminal of the output buffer 211. Second terminals of the switches SW[1] to SW[k] are respectively coupled to first terminal of the resistors RES[1] to RES[k] in a one-to-one manner. Second terminals of the resistors RES[1] to RES[k] are jointly coupled to the first terminal of the switch SW4. Resistances of the resistors RES[1] to RES[k] may be determined based on design requirement.

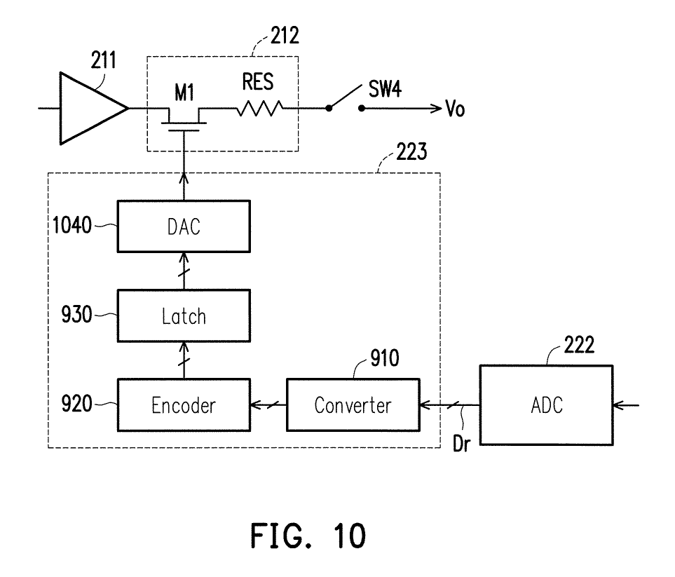

FIG. 10 is a schematic circuit block diagram of the variable resistor 212 and the controller 223 depicted in FIG. 5 according to another embodiment of the invention. The controller 223 illustrated in FIG. 10 includes the converter 910, the encoder 920, the latch 930 and a DAC 1040. The input terminal of the converter 910 is coupled to the output terminal of the ADC 222 to receive the digital value Dr. The converter 910 may convert the digital value Dr into a corresponding resistance. The corresponding resistance may represent the impedance of the data line Ch[1]. The input terminal of the encoder 920 is coupled to the output terminal of the converter 910 to receive the corresponding resistance. The encoder 920 may encode the corresponding resistance to obtain the setting value Sc[1]. The input terminal of the latch 930 is coupled to the output terminal of the encoder 920 to receive and latch the setting value Sc[1]. An input terminal of the DAC 1040 is coupled to the output terminal of the latch 930 to receive the setting value Sc[1] in a digital form. An output terminal of the DAC 1040 is coupled to the variable resistor 212 (i.e., the compensation element) to provide the setting value Sc[1] in an analog form.

The variable resistor 212 illustrated in FIG. 10 includes a transistor M1 and a resistor RES. A control terminal (e.g., a gate) of the transistor M1 is coupled to the output terminal of the DAC 1040 of the controller 223 to receive the setting value Sc[1]. A first terminal (e.g., a source) of the transistor M1 is coupled to the output terminal of the output buffer 211. A second terminal (e.g., a drain) of the transistor M1 is coupled to a first terminal of the resistor RES. A second terminal of the resistor RES is coupled to the first terminal of the switch SW4. A resistance of the resistor RES may be determined based on design requirement.

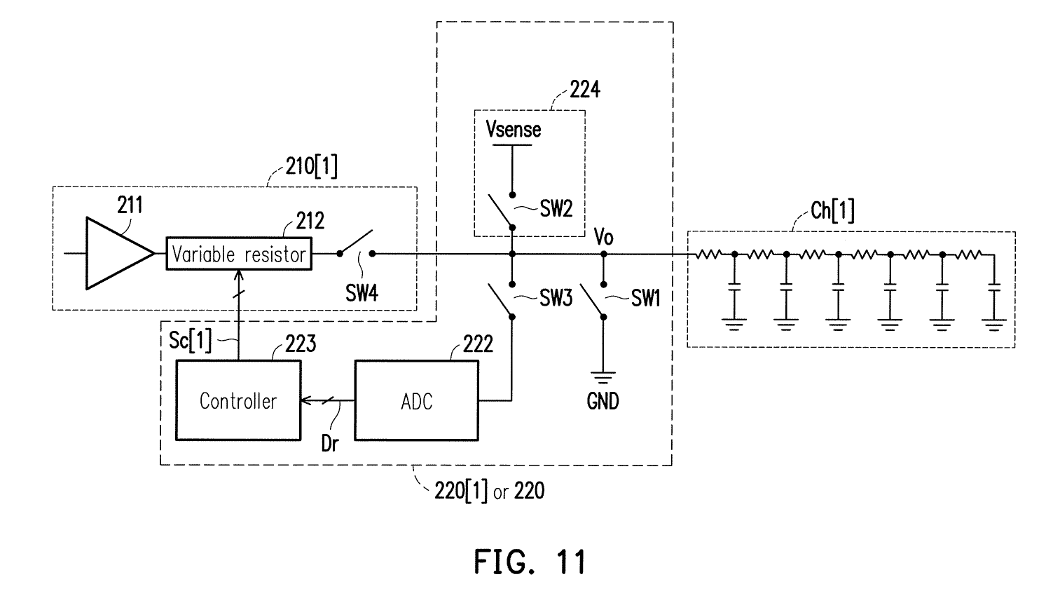

FIG. 11 is a schematic circuit block diagram of the compensation control circuit 220[1] depicted in FIG. 2 (or the compensation control circuit 220 illustrated in FIG. 3) according to another embodiment of the invention. The other compensation control circuits illustrated in FIG. 2 may be inferred with reference to the description related to the embodiment illustrated in FIG. 11. FIG. 11 further illustrates the driving channel circuit 210[1] and the data line Ch[1]. The driving channel circuit 210[1] and the data line Ch[1] illustrated in FIG. 11 may be inferred with reference to the description related to the embodiment illustrated in FIG. 5 and thus, will not be repeatedly described. The other driving channel circuits and the other data lines illustrated in FIG. 2 may be inferred with reference to the description related to embodiment illustrated in FIG. 11. The other driving channel circuits and the other data lines illustrated in FIG. 3 may also be inferred with reference to the description related to embodiment illustrated in FIG. 11.

In the embodiment illustrated in FIG. 11, the compensation control circuit 220[1] (or 220) includes the reset switch SW1, the charging source circuit 224, the detection switch SW3, the ADC 222 and the controller 223. The compensation control circuit 220[1] (or 220), the reset switch SW1, the detection switch SW3, the ADC 222 and the controller 223 illustrated in FIG. 11 may be inferred with reference to the description related to embodiment illustrated in FIG. 5 and thus, will not be repeatedly described.

The charging source circuit 221 is configured to couple to the data line Ch[1] of the display panel 120. In the charging time of the initialization period, the charging source circuit 221 charges the data line Ch[1]. In the normal operation period, the charging source circuit 224 does not influence the data line Ch[1]. In the embodiment of the FIG. 11, the charging source circuit 224 includes a voltage source Vsense and the charging switch SW2. The charging source circuit 224 and the charging switch SW2 illustrated in FIG. 11 may be inferred with reference to the descriptions related to embodiments illustrated in FIG. 5 to FIG. 8 and thus, will not be repeatedly described. The operating timings of the reset switch SW1, the charging switch SW2, the detection switch SW3 and the switch SW4 illustrated in FIG. 11 may be inferred with reference to the descriptions related to embodiments illustrated in FIG. 6 to FIG. 8.

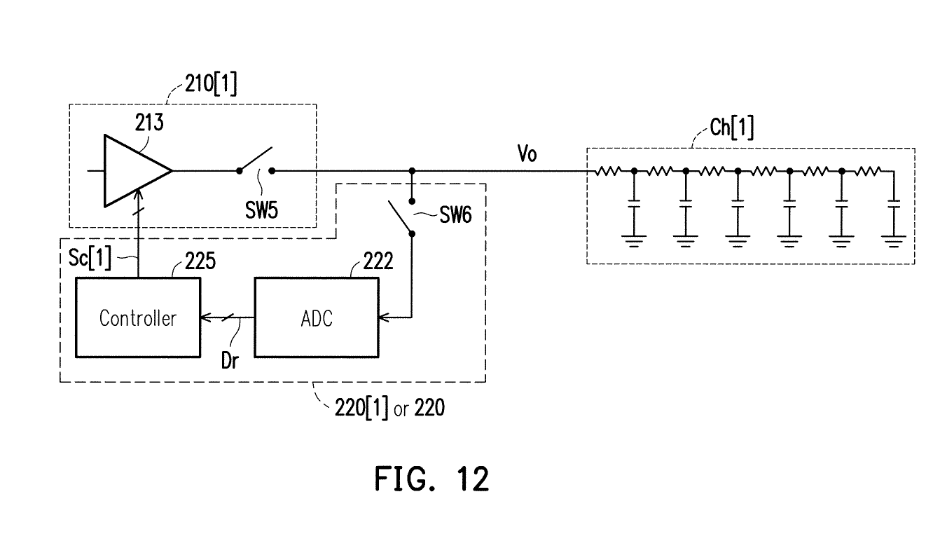

FIG. 12 is a schematic circuit block diagram of the compensation control circuit 220[1] depicted in FIG. 2 (or the compensation control circuit 220 illustrated in FIG. 3) according to yet another embodiment of the invention. The other compensation control circuits illustrated in FIG. 2 may be inferred with reference to the description related to the embodiment illustrated in FIG. 12. FIG. 12 further illustrates the driving channel circuit 210[1] and the data line Ch[1]. The driving channel circuit 210[1] and the data line Ch[1] illustrated in FIG. 12 may be inferred with reference to the description related to the embodiment illustrated in FIG. 5 and thus, will not be repeatedly described. The other driving channel circuits and the other data lines illustrated in FIG. 2 may be inferred with reference to the description related to embodiment illustrated in FIG. 12. The other driving channel circuits and the other data lines illustrated in FIG. 3 may also be inferred with reference to the description related to embodiment illustrated in FIG. 12.

The driving channel circuit 210[1] illustrated in FIG. 12 includes an output buffer 213 and a switch SW5. Based on design requirement, the driving channel circuit 210[1] may further include other elements, such as a conventional latch, a conventional DAC and so on. The aforementioned other elements (not shown) may be coupled to an input terminal of the output buffer 213. An output terminal of the output buffer 213 is configured to output a pixel voltage in the normal operation period. In the embodiment illustrated in FIG. 12, the output buffer 213 may serve as the compensation element of the driving channel circuit 210[1]. A first terminal of the switch SW5 is coupled to the output terminal of the output buffer 213. A second terminal of the switch SW5 is coupled to the data line Ch[1] of the display panel 120.

In the embodiment illustrated in FIG. 12, the compensation control circuit 220[1] (or 220) includes a detection switch SW6, the ADC 222 and a controller 225. A first terminal of the detection switch SW6 is configured to couple to the data line Ch[1] of the display panel 120. The input terminal of the ADC 222 is coupled to a second terminal of the detection switch SW6. An input terminal of the controller 225 is coupled to the output terminal of the ADC 222 to receive the digital value Dr corresponding to the resistance information with respect to the data line Ch[1]. The controller 225 converts the digital value Dr into the setting value Sc[1]. The controller 225 outputs the setting value Sc[1] to the output buffer 213 (i.e., the compensation element of the driving channel circuit 210[1]). In the embodiment illustrated in FIG. 12, the output buffer 213, the switch SW5 and the detection switch SW6 are controlled by the controller 225.

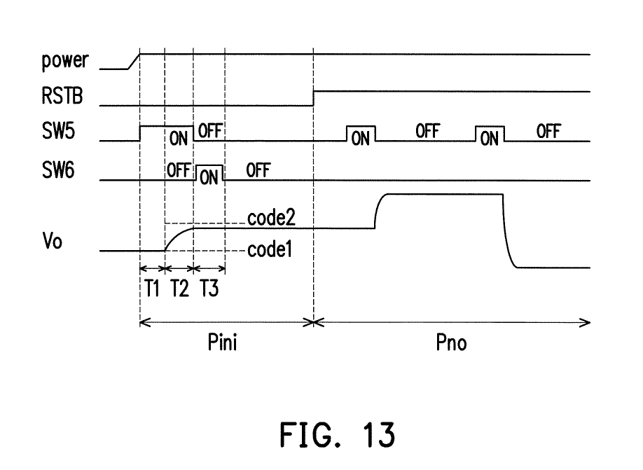

FIG. 13 is a schematic signal timing diagram of the circuits depicted in FIG. 12 according to an embodiment of the invention. In FIG. 13, the horizontal axis represents time, and the vertical axis represents voltage. The system power supply power, the system reset signal RSTB, the initialization period Pini, and the normal operation period Pno illustrated in FIG. 13 may be inferred with reference to the description related to the embodiment illustrated in FIG. 6 and thus, will not be repeatedly described.

Referring to FIG. 12 and FIG. 13, in the reset time T1 of the initialization period Pini, the detection switch SW6 is turned off, the switch SW5 is turned on, the output terminal of the output buffer 213 outputs a reset voltage code1 to the data line Ch[1] of the display panel 120. In the charging time T2 of the initialization period Pini, the detection switch SW6 is turned off, the switch SW5 is turned on, and the output terminal of the output buffer 213 outputs a charging charge to the data line Ch[1] of the display panel 120. Thus, the voltage Vo of the output terminal of the driving channel circuit 210[1] is pulled up in the charging time T2. If a length of the charging time T2 is long enough, the voltage Vo may be pulled up to a charge voltage code2. In the embodiment illustrated in FIG. 13, the charging time T2 ends in a condition that the voltage Vo is not fully charged.

Based on the descriptions related to FIG. 7 and/or FIG. 8, due to the rising speed of the voltage Vo being influenced by the impedance of the data line Ch[1], the impedance of the data line Ch[1] may be learned according to the level of the voltage Vo when the charging time T2 ends. Referring to FIG. 12 and FIG. 13, in the detection time T3 of the initialization period Pini, the switch SW5 is turned off, and the detection switch SW6 is turned on. Thus, the controller 225 may detect the resistance information with respect to the data line Ch[1] in the detection time T3. The controller 225 may convert the resistance information with respect to the data line Ch[1] into the setting value Sc[1]. After the detection time T3 ends, the detection switch SW6 is turned off. Thus, the compensation control circuit 220[1] (or 220) does not influence the operations of the driving channel circuit 210[1] and the data line Ch[1].

After the initialization period Pini ends, the driving IC 200 or 300 enters the normal operation period Pno. The compensation control circuit 220[1] (or 220) illustrated in FIG. 12 may output the setting value Sc[1] to the driving channel circuit 210[1] to adjust the output resistance value, the output slew rate or the output timing of the output terminal of the driving channel circuit 210[1]. In the normal operation period Pno, the detection switch SW6 is turned off. In each of scan line periods of the normal operation period Pno, the switch SW5 is turned on (illustrated in FIG. 13).

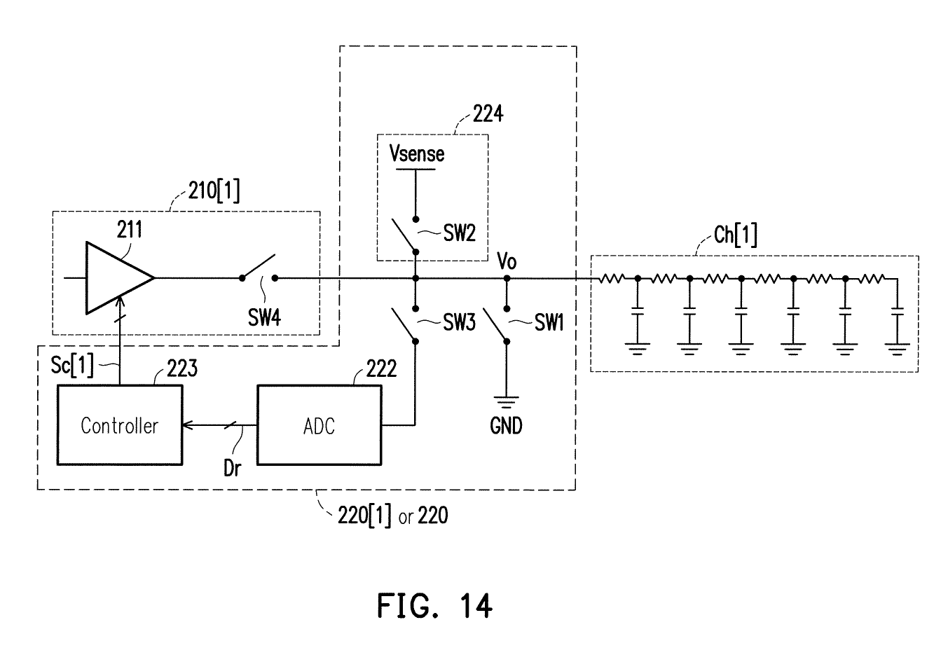

FIG. 14 is a schematic circuit block diagram of the compensation control circuit 220[1] depicted in FIG. 2 (or the compensation control circuit 220 illustrated in FIG. 3) according to still another embodiment of the invention. The other compensation control circuits illustrated in FIG. 2 may be inferred with reference to the description related to embodiment illustrated in FIG. 14. FIG. 14 further illustrates the driving channel circuit 210[1] and the data line Ch[1]. The driving channel circuit 210[1] and the data line Ch[1] illustrated in FIG. 14 may be inferred with reference to the description related to the embodiment illustrated in FIG. 5 and thus, will not be repeatedly described. The other driving channel circuits and the other data lines illustrated in FIG. 2 may be inferred with reference to the description related to embodiment illustrated in FIG. 14. The other driving channel circuits and the other data lines illustrated in FIG. 3 may also be inferred with reference to the description related to embodiment illustrated in FIG. 14.

In the embodiment illustrated in FIG. 14, the compensation control circuit 220[1] (or 220) includes the reset switch SW1, the charging source circuit 224, the detection switch SW3, the ADC 222 and the controller 223. The compensation control circuit 220[1] (or 220), the reset switch SW1, the detection switch SW3, the ADC 222 and the controller 223 illustrated in FIG. 14 may be inferred with reference to the description related to embodiment illustrated in FIG. 11 and thus, will not be repeatedly described.

In the embodiment illustrated in FIG. 14, the driving channel circuit 210[1] includes the output buffer 211 and the switch SW4. Based on design requirement, the driving channel circuit 210[1] may further include other elements, such as a conventional latch, a conventional DAC and so on. The aforementioned other elements (not shown) may be coupled to the input terminal of the output buffer 211. The output terminal of the output buffer 211 is configured to output a pixel voltage.

In the embodiment illustrated in FIG. 14, the output buffer 211 may serve as the compensation element of the driving channel circuit 210[1]. The output buffer 211 may adjust the output slew rate or the output timing of the output terminal of the output buffer 211 according to the setting value Sc[1] of the compensation control circuit 220[1] (or 220). The first terminal of the switch SW4 is coupled to the output terminal of the output buffer 211. The second terminal of the switch SW4 is coupled to the data line Ch[1] of the display panel 120. The operating timings of the reset switch SW1, the charging switch SW2, the detection switch SW3 and the switch SW4 illustrated in FIG. 14 may be inferred with reference to the descriptions related to embodiments illustrated in FIG. 6 to FIG. 8 and thus, will not be repeatedly described.

It should be noted that in various application scenarios, related functions of the compensation control circuit 220[1], the compensation control circuit 220 and/or the controller 223 may be implemented as software, firmware or hardware by using general purpose programming languages (e.g., C or C++), hardware description languages (e.g., Verilog HDL or VHDL) or other suitable programming languages. The software (or firmware) capable of executing the functions may be deployed in any computer-accessible media, such as magnetic tapes, semiconductor memories, magnetic disks or compact disks (e.g., CD-ROM or DVD-ROM) or may be delivered through the Internet, wired communication, wireless communication or other communication media. The software (or firmware) may be stored in the computer-accessible media for a processor of the computer to access/execute the programming codes of the software (or firmware). Moreover, the device and the method of the invention may be implemented by means of a combination of hardware and software.

Based on the above, in the driving IC and the fan-out compensation method thereof provided by the embodiments of the invention, the compensation control circuit is used. The compensation control circuit can perform a loading detection operation on the panel to obtain the resistance information with respect to each corresponding data line. The compensation control circuit can obtain the corresponding setting value through calculation using an algorithm, so as to adjust the output capability or the output timing of the driving IC. Based on design requirement, the adjustment of the output capability or the output timing can include the adjustment of the output resistance values, the output slew rates or the output timings of the output terminals of the driving channel circuits. The adjustment of the output capability or the output timing of the driving IC can compensate the delay difference caused by the resistance difference among the data line, so as to prevent the panel from screen abnormality due to impedance mismatch of the data lines.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A driving integrated circuit (IC), configured to drive a display panel, comprising:
a driving channel circuit, having an output terminal configured to couple to a data line of the display panel, wherein the driving channel circuit is configured to output a pixel voltage to drive the data line in a normal operation period and comprises a compensation element configured to adjust an output resistance value, an output slew rate or an output timing of the output terminal of the driving channel circuit according to a setting value; and
a compensation control circuit, coupled to the data line of the display panel and the compensation element of the driving channel circuit, wherein the compensation control circuit is configured to detect resistance information with respect to the data line in an initialization period, correspondingly adjust the setting value according to the resistance information and output the setting value to the compensation element.

2. The driving IC according to claim 1, wherein the driving channel circuit comprises:
an output buffer, having an output terminal configured to output the pixel voltage;
a variable resistor, having a first terminal coupled to the output terminal of the output buffer, wherein the variable resistor is controlled by the setting value of the compensation control circuit to adjust a resistance value of the variable resistor and serves as the compensation element; and
a switch, having a first terminal and a second terminal respectively coupled to a second terminal of the variable resistor and the data line of the display panel, wherein the switch is turned off in the initialization period, and the switch is turned on in the normal operation period.

3. The driving IC according to claim 1, wherein the driving channel circuit comprises:
an output buffer, having an output terminal configured to output the pixel voltage, wherein the output buffer serves as the compensation element and is configured to adjust an output slew rate or an output timing of the output terminal of the output buffer according to the setting value; and
a switch, having a first terminal and a second terminal respectively coupled to an output terminal of the output buffer and the data line of the display panel, wherein the switch is turned off in the initialization period, and the switch is turned on in the normal operation period.

4. The driving IC according to claim 1, wherein the compensation control circuit comprises:
a charging source circuit, configured to couple to the data line of the display panel, wherein the charging source circuit charges the data line in a charging time of the initialization period, and does not influence the data line in the normal operation period;
a detection switch, having a first terminal configured to couple to the data line of the display panel, wherein the detection switch is turned on in a detection time of the initialization period, and the detection switch is turned off in the normal operation period;
an analog-to-digital converter (ADC), having an input terminal coupled to a second terminal of the detection switch; and
a controller, having an input terminal coupled to an output terminal of the ADC to receive a digital value corresponding to the resistance information, wherein the controller converts the digital value into the setting value, and outputs the setting value to the compensation element.

5. The driving IC according to claim 4, wherein the charging source circuit comprises:
a current source; and
a charging switch, having a first terminal and a second terminal, wherein the first terminal of the charging switch is coupled to a current output terminal of the current source, the second terminal of the charging switch is configured to couple to the data line of the display panel, the charging switch is turned on in the charging time, and the charging switch is turned off in the normal operation period.

6. The driving IC according to claim 4, wherein the charging source circuit comprises:
a voltage source; and
a charging switch, having a first terminal and a second terminal, wherein the first terminal of the charging switch is coupled to a voltage output terminal of the voltage source, the second terminal of the charging switch is configured to couple to the data line of the display panel, the charging switch is turned on in the charging time, and the charging switch is turned off in the normal operation period.

7. The driving IC according to claim 4, wherein the compensation control circuit further comprises:
a reset switch, having a first terminal and a second terminal, wherein the first terminal of the reset switch is configured to couple to the data line of the display panel, the second terminal of the reset switch is coupled to a reset voltage, the reset switch is turned on in a reset time of the initialization period, and the reset switch is turned off in the normal operation period.

8. The driving IC according to claim 4, wherein the controller comprises:
a converter, having an input terminal coupled to the output terminal of the ADC to receive the digital value, and configured to convert the digital value into a corresponding resistance;
an encoder, having an input terminal coupled to an output terminal of the converter to receive the corresponding resistance, and configured to encode the corresponding resistance to obtain the setting value;
a latch, having an input terminal coupled to an output terminal of the encoder to receive the setting value, and configured to latch the setting value; and
a level shifter, having an input terminal and an output terminal, wherein the input terminal of the level shifter is coupled to an output terminal of the latch to receive the setting value, and the output terminal of the level shifter is coupled to the compensation element to provide the setting value.

9. The driving IC according to claim 4, wherein the controller comprises:
a converter, having an input terminal coupled to the output terminal of the ADC to receive the digital value, and configured to convert the digital value into a corresponding resistance;
an encoder, having an input terminal coupled to an output terminal of the converter to receive the corresponding resistance, and configured to encode the corresponding resistance to obtain the setting value;
a latch, having an input terminal coupled to an output terminal of the encoder to receive the setting value, and configured to latch the setting value; and
a digital-to-analog converter (DAC), having an input terminal and an output terminal, wherein the input terminal of the DAC is coupled to an output terminal of the latch to receive the setting value in a digital form, the output terminal of the DAC is coupled to the compensation element to provide the setting value in an analog form.

10. The driving IC according to claim 1, wherein the driving channel circuit comprises:
an output buffer, having an output terminal configured to output the pixel voltage in the normal operation period, wherein the output terminal of the output buffer outputs a reset voltage in a reset time of the initialization period, and the output terminal of the output buffer outputs a charging charge in a charging time of the initialization period; and
a switch, having a first terminal and a second terminal respectively coupled to the output terminal of the output buffer and the data line of the display panel, wherein the switch is turned on in the reset time, the charging time and a scan line period, and the switch is turned off in a detection time of the initialization period.

11. The driving IC according to claim 1, wherein the compensation control circuit comprises:
a detection switch, having a first terminal configured to couple to the data line of the display panel, wherein the detection switch is turned on in a detection time of the initialization period, and the detection switch is turned off in the normal operation period;
an analog-to-digital converter (ADC), having an input terminal coupled to a second terminal of the detection switch; and
a controller, having an input terminal coupled to an output terminal of the ADC to receive a digital value corresponding to the resistance information, wherein the controller converts the digital value into the setting value, and outputs the setting value to the compensation element.

12. A fan-out compensation method of a driving IC configured to drive a display panel, the fan-out compensation method comprising:
outputting a pixel voltage to drive a data line of the display panel in a normal operation period by an output terminal of a driving channel circuit;
detecting resistance information with respect to the data line in an initialization period by a compensation control circuit;
correspondingly adjusting a setting value according to the resistance information by the compensation control circuit; and
outputting the setting value to the driving channel circuit to adjust an output resistance value, an output slew rate or an output timing of the output terminal of the driving channel circuit by the compensation control circuit.

13. The fan-out compensation method according to claim 12, wherein the step of detecting the resistance information with respect to the data line comprises:
charging the data line in a charging time of the initialization period; and
detecting the resistance information with respect to the data line in a detection time of the initialization period.

14. The fan-out compensation method according to claim 13, wherein the step of detecting the resistance info′ illation with respect to the data line further comprises:
coupling the data line of the display panel to a reset voltage in a reset time of the initialization period.
